(19) United States
(12) Patent Application Publication
(10) Pub. No.: US 2016/0234617 A1
(43) Pub. Date: Aug. 11, 2016

(54) METHOD FOR PRODUCING A FILM FOR A LOUDSPEAKER DIAPHRAGM OR A MICROPHONE DIAPHRAGM

(71) Applicant: ISOVOLTA AG, Wiener Neudorf (AT)

(72) Inventors: Christian Zechner, Gröbming (AT); Peter Pertl, Graz (AT)

(21) Appl. No.: 15/024,273

(22) PCT Filed: Oct. 10, 2014
(86) PCT No.: PCT/EP2014/071761

§ 371 Date: Mar. 24, 2016

(30) Foreign Application Priority Data
Oct. 11, 2013 (EP) 13188270.6

(51) Int. Cl. H04R 31/00; B29C 47/06; B32B 27/08; B32B 27/32; B29C 47/00; B32B 37/18

(52) U.S. Cl. CPC H04R 31/003; B29C 47/0064; B32B 37/182; B32B 27/08; B32B 27/32; B29C 47/065; H04R 2307/025; B32B 2325/00; B32B 2457/00; B29L 2031/38

(57) ABSTRACT

The invention relates to a method for producing a film for a loudspeaker diaphragm or a microphone diaphragm from a thermoplastic elastomer and is characterized in that a thermoplastic elastomer is shaped to a film by extrusion.

The present invention relates to a method for producing a film for a loudspeaker diaphragm or a microphone diaphragm.

Electromagnetic transducers are used for various types of loudspeakers and microphones, in particular also for miniature loudspeakers as applied in mobile phones, notebooks, tablets, gaming consoles, earphones, hands-free speakerphones, modern televisions and also in the automotive sector.

A general market trend shows that the structural shape of such loudspeakers does not allow a uniform design and demands great flexibility from manufacturers. In addition, smallest structural shapes with maximum performance are often expected. Nevertheless, highest requirements are placed on the acoustic quality. All those requirements make tremendous technological demands on the diaphragm, which functions as the centrepiece of a loudspeaker or microphone, respectively.

In order to meet those requirements, manufacturers of miniature loudspeakers employ multifunctional multilayer films as diaphragm materials. Due to their structure, they can be specifically adjusted to the requirements of the acoustic system. A basic feature of those multilayer films is the thermoplastic matrix which provides possibilities of acoustic optimization to processors of those diaphragm materials and allows maximum flexibility in designing.

From US 2004/0112671 A1, a loudspeaker diaphragm is known which is constructed in three layers: upon a fabric as a base, one or two layers of a thermoplastic resin is/are applied. From US 2012/0060997 A1, a film is known comprising at least one film of a polypropylene homopolymer with a modifier. From U.S. Pat. No. 4,761,451, an acoustic vibration diaphragm made of polypropylene and a thermoplastic styrene block copolymer is known. On the other hand, from EP 1 113 704 A2, a diaphragm for a loudspeaker is known, wherein the diaphragm comprises a foam of a base resin from an aromatic polycarbonate, namely to an amount of at least 50% by weight.

The resonant frequency of micro-loudspeakers as known today and comprising multi-layered diaphragm films with mechanically solid external layers and a flexible core layer ranges from 600 Hz to 1000 Hz, depending on the structure and the design. However, those frequencies are located in the application range of miniature loudspeakers, which may lead to undesired acoustic effects.

In order to achieve low resonant frequencies, silicones are also used as diaphragm materials. With silicone, natural frequencies of the diaphragm can be adjusted to clearly below those of multilayer films. For those acoustic applications, silicones are processed by injection moulding, whereby they already obtain their final design. As a result of this processing concept, a substantial processing step, i.e. thermoforming, may be omitted.

From EP 2 268 058 A1, a diaphragm for a micro-loudspeaker as well as a method of produding the diaphragm are known. The diaphragm comprises an elastomer having a thickness of less than 0.3 mm and a Young's modulus of below 100 MPa. In EP 2 268 058 A1, it is pointed out that a diaphragm can be produced from an elastomer by means of an injection-moulding technique and that said technique allows a very stable manufacturing process with minor variations in the diaphragm thickness. In addition, it is said that little waste accumulates during injection moulding—in contrast to the deep-drawing technique.

It is the first objective of the present invention to provide an alternative method for producing a film for a loudspeaker diaphragm or a microphone diaphragm.

The method according to the invention for producing a film for a loudspeaker diaphragm or a microphone diaphragm from a thermoplastic elastomer is characterized in that a thermoplastic elastomer is shaped to a film by extrusion.

It has been shown that, by means of the extrusion technique, it is easily possible to produce films which can be processed further into a loudspeaker diaphragm or a microphone diaphragm exhibiting very good acoustic properties.

A preferred embodiment of the method according to the invention for producing an at least two-layered film consists in that the extrusion is conducted as a co-extrusion with at least one thermoplastic elastomer.

The co-extrusion can be performed with at least two chemically different thermoplastic elastomers or with the thermoplastic elastomer and at least one thermoplastic material.

A further preferred embodiment of the method according to the invention for producing an at least two-layered film consists in that, upon a film produced from a thermoplastic elastomer by extrusion, at least one further film optionally produced from a thermoplastic material by extrusion is laminated.

It has been shown that SBS (=styrene-butadiene block copolymer), SEBS (=styrene-ethylene-butylene-styrene block copolymer), copolyester and/or polyamide is/are very suitable for the production of the film as a thermoplastic elastomer, with SEBS and/or SBS being particularly preferred.

The extrusion or co-extrusion, respectively, is performed best in such a way that the film exhibits a thickness ranging between 10 μm and 300 μm.

Furthermore, the invention relates to a film which is produced according to the method of the invention and is designed as a monofilm, with SBS and/or SEBS being provided as the thermoplastic elastomer.

In addition, the present invention relates to the use of a film produced according to the method of the invention for the production of a loudspeaker diaphragm, wherein said production can be effected according to a method known from the prior art.

The film according to the invention allows lower resonant frequency ranges and attenuates better than monofilms made of silicone and other monofilms known from the prior art. It has been possible to demonstrate in comparative experiments that, e.g., the resonant frequency of an SEBS film amounts to approx. 8.8 Hz, whereas the resonant frequencies of a comparable PE-HD film (=high-density polyethylene) and a PET film (PET=polyethylene terephthalate) amount to 21.3 Hz and 68.5 Hz, respectively. On the other hand, the films according to the invention have a substantially better attenuation as compared to a silicone film which exhibits a low resonant frequency comparable to the films according to the invention, whereby the films according to the invention are much better suited for micro-loudspeakers and microphones.

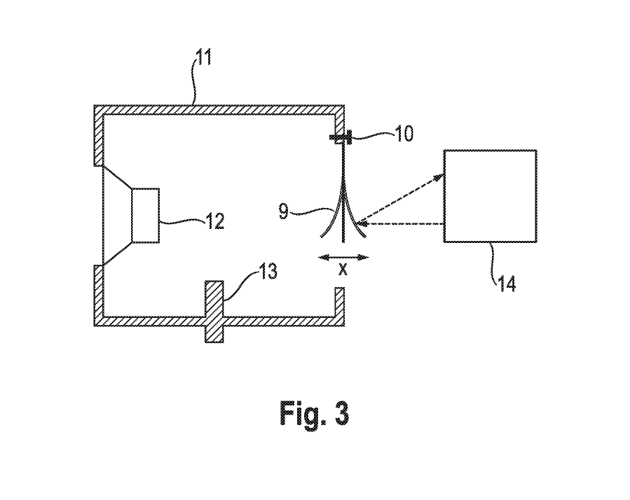

The resonant frequency, the attenuation behaviour and the modulus of elasticity of polymeric film materials are determined as follows, with the measuring device being schematically shown in FIG. 3:

A film test strip 9 of the typical dimension 10×15 mm is clamped on one side into the test box 11 by means of a clamping device 10. The sample is stimulated pneumatically by sinusoidal acoustic waves generated by a loudspeaker 12 performing a frequency sweep. During the measurement, the acoustic pressure within the test box is measured by means of a microphone 13 and, in parallel, the deflections of the test piece x are measured by means of a laser sensor 14. The data are supplied to an analyzer hardware and, on the basis of given data (geometry, mass), the resonant frequency, the loss factor (attenuation) and the modal modulus of elasticity are calculated.

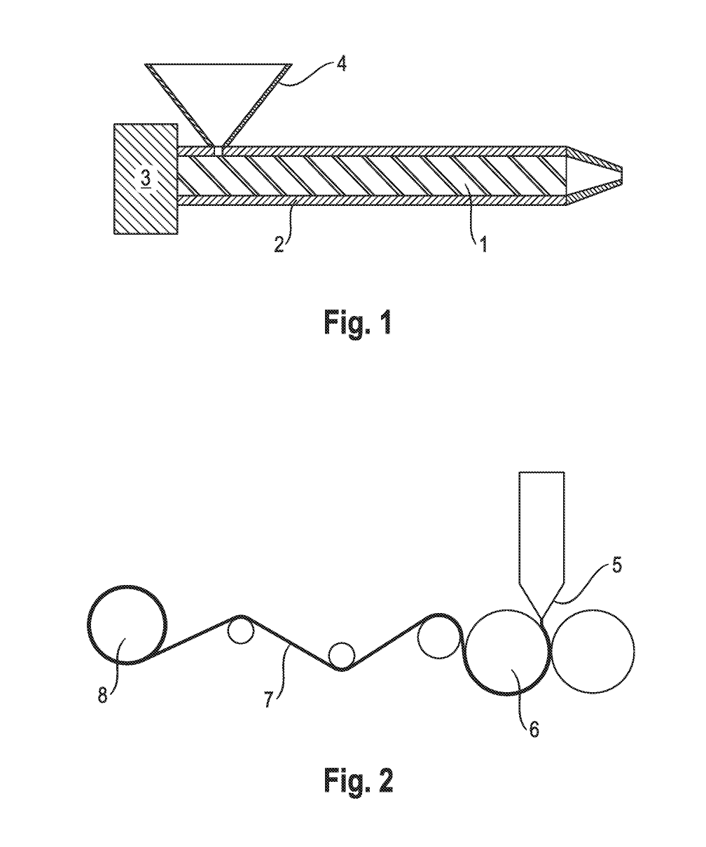

The method according to the invention can be performed on conventional extruders comprising a film die. In the drawing, FIG. 1 schematically shows in section the structure of an extruder, comprising the screw 1 which is located in the cylinder 2. The drive is schematically indicated by 3. Reference numeral 4 represents the feed hopper. FIG. 2 schematically shows the facility for film extrusion with a slot die 5 for the extrusion of the film 7, which, at first, is drawn off via a chill roller 6 and eventually is rolled up (roll 8).

For the production of monofilms, a polymer melt extruder may thus be used. In order to produce multilayer films, a lamination may subsequently occur. Several extruders and multilayer dies may also be used for the production of co-extruded multilayer films.

The processing temperature in the extruder ranges from 160° C. to 250° C.

In the film extrusion process, an air knife or a pressure roller, respectively, may be used for smoothening the film.

The stretching of the film preferably occurs between the die outlet and the cooling roller at haul-off speeds ranging from 20 m/min to 500 m/min.

1-9. (canceled)

10. A method for producing a film from a thermoplastic elastomer for a loudspeaker diaphragm or a microphone diaphragm, comprising:
shaping a thermoplastic elastomer into a film by extrusion.

11. A method according to claim 10, wherein shaping the thermoplastic elastomer into a film comprises co-extruding at least one thermoplastic elastomer to produce an at least two-layered film.

12. A method according to claim 11, wherein the co-extruding is performed with at least two chemically different thermoplastic elastomers or with the thermoplastic elastomer and at least one thermoplastic material.

13. A method according to claim 10, further comprising laminating the film shaped by extrusion of the thermoplastic elastomer with at least one additional film to produce an at least two-layered film.

14. A method according to claim 13, wherein the at least one additional film is produced by extruding a thermoplastic material.

15. A method according to claim 10, wherein the thermoplastic elastomer is selected from the group consisting of styrene-butadiene block copolymer (SBS), styrene-ethylene-butylene-styrene block copolymer (SEBS), copolyester and polyamide.

16. A method according to claim 15, wherein the thermoplastic elastomer comprises SEBS and/or SBS.

17. A method according to claim 10, wherein the extruding is performed in such a way that the film has a thickness ranging between 10 μm and 300 μm.

18. A method according to claim 11, wherein the co-extruding is performed in such a way that the film has a thickness ranging between 10 μm and 300 μm.

19. A method according to claim 10, further comprising forming the film into a loudspeaker diaphragm or a microphone diaphragm.

20. A film produced according to claim 10, which film is designed as a monofilm and contains SBS or SEBS as the thermoplastic elastomer.

21. A loudspeaker diaphragm or a microphone diaphragm formed from the film produced according to claim 10.
